(19) United States
(12) Patent Application Publication
(10) Pub. No.: US 2026/0245227 A1
(43) Pub. Date: Aug. 20, 2026

(54) SYSTEM AND METHOD OF DEPTH ESTIMATION FOR A VIDEO IN AN EVENT-SENSOR ENABLED ELECTRONIC DEVICE

(71) Applicant: SAMSUNG ELECTRONICS CO., LTD., Suwon-si (KR)

(72) Inventors: Amrit Kumar MUDULI, Bangalore (IN); Kunal SWAMI, Bangalore (IN); Vikash KUMAR, Bangalore (IN); Shruti GUPTA, Bangalore (IN)

(73) Assignee: SAMSUNG ELECTRONICS CO., LTD., Suwon-si (KR)

(21) Appl. No.: 19/543,424

(22) Filed: Feb. 18, 2026

Related U.S. Application Data
(63) Continuation of application No. PCT/KR2026/002550, filed on Feb. 11, 2026.

(30) Foreign Application Priority Data
Feb. 19, 2025 (IN) 202541014217

(51) Int. Cl. G06T 7/50; G06T 3/14

(52) U.S. Cl. CPC G06T 7/50; G06T 3/14

(57) ABSTRACT

A method for depth estimation of a video includes capturing a current video frame and one or more previous video frames of a scene using a camera of an electronic device; estimating a depth map for each of the current video frame and the one or more previous video frames; capturing one or more event frames over a time period between the current video frame and each of the one or more previous video frames using an event-sensor of the electronic device, wherein each of the one or more event frames includes pixels which have changed in video frames; aligning the depth map of the one or more previous video frames with the depth map of the current video frame using a change in pixel intensities indicated by the one or more event frames; and fusing the aligned depth map of the one or more previous video frames with the depth map of the current video frame to generate an updated depth map of the video.

### CROSS REFERENCE TO RELATED APPLICATION(S)

This application is a bypass continuation application of International Application No. PCT/KR2026/002550, filed on Feb. 11, 2026, which is based on and claims priority to Indian Patent Application No.: 202541014217 filed on Feb. 19, 2025 in the Indian Intellectual Property Office, the disclosures of which is incorporated by reference herein in its entirety.

### BACKGROUND

### 1. Field

One or more embodiments of the present disclosure relate to video depth estimation, and more particularly relates to a system and method of video depth estimation in an event-sensor enabled electronic device, to generate consistent depth map of the video.

### 2. Description of Related Art

While capturing a scene using a camera of an electronic device, only two-dimensional (2D) representation of the scene may be obtained at that particular moment. While the camera captures the information of the objects in the scene from the particular view where the camera stands, it may lose the information of the depth (i.e., the third dimension (3D) which we observe in our 3D reality). In the field of computer vision, depth estimation may include determining the distance of the objects from the camera, transforming 2D images into 3D representations. Also, depth information may indicate insight into object positioning, shape, and distance, critical for applications that require a true 3D understanding of the captured image.

Depth information may be used for various applications. For example, robots may navigate, recognize objects, and interact safely within their environment based on depth estimation. Likewise, in augmented and virtual reality (AR/VR), depth estimation may be performed to seamlessly blend virtual elements with the physical world, creating immersive and interactive experiences. Additionally, depth estimation may be performed for aesthetic enhancements in photography, such as producing a bokeh effect or portrait relighting, giving images a professional and refined quality.

The information disclosed in this background of the disclosure section is only for enhancement of understanding of the general background of the invention and should not be taken as an acknowledgement or any form of suggestion that this information forms the prior art already known to a person skilled in the art.

### SUMMARY

However, depth estimation may be a complex task with multiple requirements beyond mere accuracy, especially for video. The challenge may lie not only in estimating precise depth but also in maintaining temporal consistency across frames and managing dynamic scenes, where objects or the camera itself may be in motion.

Some depth estimation techniques may not be performed in real-time, which limits their application in scenarios that demand immediate depth information of the video. Also, some techniques may not handle the blurriness of the motion effectively while estimating the depth of each frame.

Therefore, techniques of depth estimation can be improved to solve at least the aforementioned technical problems.

This summary is provided to introduce a selection of concepts, in a simplified format, which is further described in the detailed description of the invention. This summary is neither intended to identify key or essential inventive concepts of the invention nor is it intended for determining the scope of the invention.

According to an aspect of one or more embodiments of the present disclosure, a method for depth estimation of a video may include capturing a current video frame and one or more previous video frames of a scene using a camera of an electronic device; estimating a depth map for each of the current video frame and the one or more previous video frames; capturing one or more event frames over a time period between the current video frame and each of the one or more previous video frames using an event-sensor of the electronic device, wherein each of the one or more event frames includes pixels which have changed in video frames; aligning the depth map of the one or more previous video frames with the depth map of the current video frame using a change in pixel intensities indicated by the one or more event frames; and fusing the aligned depth map of the one or more previous video frames with the depth map of the current video frame to generate an updated depth map of the video.

The camera of the electronic device may be an RGB camera.

The method of aligning of the depth map of the one or more previous video frames with the depth map of the current video frame may include applying temporal transformation to the depth map of each of the one or more previous video frames; and spatially shifting depth values of pixels of each of the one or more previous video frames to align with corresponding pixel positions in the current video frame based on the temporal transformation.

The method of aligning of the depth map of the one or more previous video frames with the depth map of the current video frame may further include for each of the one or more previous video frames, iteratively: generating a plurality of affinity matrices based on the current video frame, a respective previous video frame, and a corresponding event frame; and spatially shifting the depth values of pixels of the respective previous video frame to align with the corresponding pixel positions in the current video frame based on the plurality of affinity matrices.

The method of aligning of the depth map of the one or more previous video frames with the depth map of the current video frame may further include identifying a set of pixels of the one or more previous video frames to apply the temporal transformation based on the change in pixel intensities captured in the one or more event frames, the set of pixels corresponding to spatial movement during the time period. The temporal transformation may be applied only to the identified set of pixels of the one or more previous video frames.

The method of fusing the aligned depth map of the one or more previous video frames with the depth map of the current video frame may include fusing an weighted average of the aligned depth map with the depth map of the current video frame based on corresponding one or more event frames. The weighted average may differentiate slow and fast moving pixels based on the change in pixel intensities.

The method may further include generating, based on the one or more event frames, event embedding that indicates the change in pixel intensities.

According to another aspect of one or more embodiments of the present disclosure, a system to estimate depth for a video may include at least one processor and memory storing at least one instruction. The at least one instruction, when executed by the at least one processor individually or collectively, may cause the system to capture, using a camera, a current video frame and one or more previous video frames of a scene; estimate a depth map for each of the current video frame and the one or more previous video frames; capture, using an event-sensor, one or more event frames during a time period between the current video frame and each of the one or more previous video frames, wherein each of the one or more event frames includes pixels which have changed in video frames; align the depth map of the one or more previous video frames with the depth map of the current video frame using a change in pixel intensities indicated by the one or more event frames; and fuse the aligned depth map of the one or more previous video frames with the depth map of the current video frame to generate an updated depth map of the video.

The camera of the electronic device is an RGB camera.

The at least one instruction, when executed by the at least one processor individually or collectively, may further cause the system to apply temporal transformation to the depth map of each of the one or more previous video frames; and spatially shift depth values of pixels of each of the one or more previous video frames to align with corresponding pixel positions in the current video frame based on the temporal transformation.

The at least one instruction, when executed by the at least one processor individually or collectively, may further cause the system to for each of the one or more previous video frames, iteratively: generate a plurality of affinity matrices based on the current video frame, a respective previous video frame, and corresponding event frame; and spatially shift the depth values of pixels of the respective previous video frame to align with the corresponding pixel positions in the current video frame based on the plurality of affinity matrices.

The at least one instruction, when executed by the at least one processor individually or collectively, may further cause the system to identify a set of pixels of the one or more previous video frames to apply the temporal transformation based on the change in pixel intensities captured in the one or more event frames, the set of pixels corresponding to spatial movement during the time period. The temporal transformation may be applied only to the identified set of pixels of the one or more previous video frames.

The at least one instruction, when executed by the at least one processor individually or collectively, may further cause the system to fuse an weighted average of the aligned depth map with the depth map of the current video frame based on corresponding one or more event frames. The weighted average may be to differentiate slow and fast moving pixels based on the change in pixel intensities.

The at least one instruction, when executed by the at least one processor individually or collectively, may further cause the system to generate, based on the one or more event frames, event embedding that indicates the change in pixel intensities.

According to another aspect of one or more embodiments of the present disclosure, a non-transitory computer readable storage medium storing instructions that, when executed by one or more processors, may cause the electronic device to capture, using a camera, a current video frame and one or more previous video frames of a scene; estimate a depth map for each of the current video frame and the one or more previous video frames; capture, using an event-sensor, one or more event frames during a time period between the current video frame and each of the one or more previous video frames, wherein each of the one or more event frames includes pixels which have changed in video frames; align the depth map of the one or more previous video frames with the depth map of the current video frame using a change in pixel intensities indicated by the one or more event frames; and fuse the aligned depth map of the one or more previous video frames with the depth map of the current video frame to generate an updated depth map of the video.

The camera of the electronic device is an RGB camera.

The instructions further include instructions that, when executed by one or more processors, may cause the electronic device to apply temporal transformation to the depth map of each of the one or more previous video frames; and spatially shift depth values of pixels of each of the one or more previous video frames to align with corresponding pixel positions in the current video frame based on the temporal transformation.

The instructions further include instructions that, when executed by one or more processors, may cause the electronic device to for each of the one or more previous video frames, iteratively: generate a plurality of affinity matrices based on the current video frame, a respective previous video frame, and corresponding event frame; and spatially shift the depth values of pixels of the respective previous video frame to align with the corresponding pixel positions in the current video frame based on the plurality of affinity matrices.

The instructions further include instructions that, when executed by one or more processors, may cause the electronic device to identify a set of pixels of the one or more previous video frames to apply the temporal transformation based on the change in pixel intensities captured in the one or more event frames, the set of pixels corresponding to spatial movement during the time period. The temporal transformation may be applied only to the identified set of pixels of the one or more previous video frames.

The instructions further include instructions that, when executed by one or more processors, may cause the electronic device to fuse an weighted average of the aligned depth map with the depth map of the current video frame based on corresponding one or more event frames. The weighted average may be to differentiate slow and fast moving pixels based on the change in pixel intensities.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a block diagram of a system to estimate depth for a video in an event sensor enabled electronic device, in accordance with an embodiment of the present disclosure;

FIG. 2A illustrates a block diagram of an implementation of various modules of the system, to estimate depth for a video in an event-sensor enabled electronic device, in accordance with an embodiment of the present disclosure;

FIG. 2B illustrates a device with an RGB camera, an event sensor camera, and the timeline of their corresponding captured frames, in accordance with an embodiment of the present disclosure;

FIG. 3A illustrates an explanation of captured event frames using an event sensor camera of an electronic device, in accordance with an embodiment of the present disclosure;

FIG. 3B illustrates an example illustrating captured event frame using the event sensor camera of the electronic device, in accordance with an embodiment of the present disclosure;

FIG. 3C illustrates yet another example of captured event frames using the event sensor camera of the electronic device, in accordance with an embodiment of the present disclosure;

FIG. 4A illustrates an explanation of an event embedding module to generate event embeddings, in accordance with an embodiment of the present disclosure;

FIG. 4B illustrates yet another explanation of the event embedding module to generate event embeddings, in accordance with an embodiment of the present disclosure;

FIG. 5 illustrates a network architecture of a temporal propagation module, in accordance with an embodiment of the present disclosure;

FIG. 6 illustrates an example to explain the temporal propagation module, in accordance with an embodiment of the present disclosure;

FIG. 7 illustrates a network architecture of a depth fusion module, in accordance with an embodiment of the present disclosure; and

FIG. 8 illustrates a sequence flow of a method of depth estimation for a video in an event-sensor enabled electronic device, in accordance with an embodiment of the present disclosure.

The FIGS. depict embodiments of the disclosure for purposes of illustration only. One skilled in the art will readily recognize from the following description that alternative embodiments of the structures and methods illustrated herein may be employed without departing from the principles of the disclosure described herein.

It should be appreciated by those skilled in art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described and will be described in detail below. It should be understood that, however it is not intended to limit the disclosure is to cover all modifications, equivalents, and alternatives falling within the spirit and the scope of the disclosure.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into one or more embodiments of the present disclosure as if it were individually recited herein.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in art to practice the disclosure, and it is to be understood that other embodiments may be utilized and that changes may be made without departing from the scope of the disclosure. The following description is, therefore, not to be taken in a limiting sense.

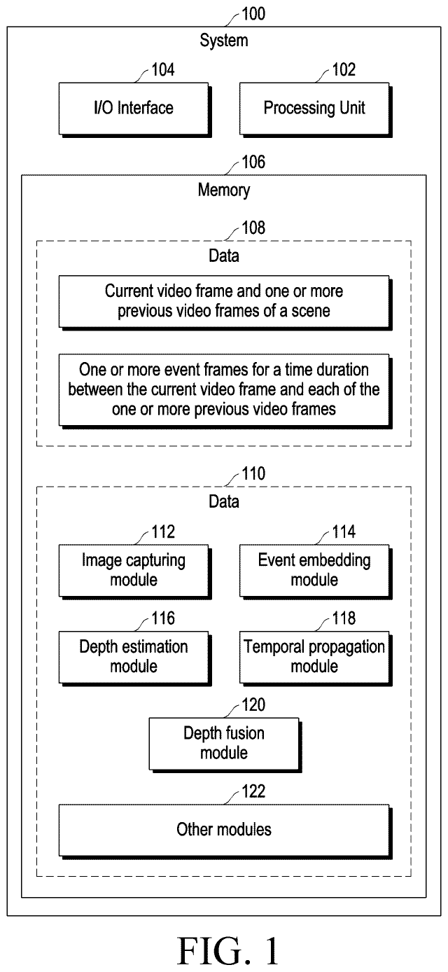

FIG. 1 illustrates a block diagram of a system 100 to estimate depth for a video in an event sensor enabled electronic device, in accordance with an embodiment of the present disclosure. The system 100 may comprise a processing unit 102 comprising at least one processor, an input/output (I/O) interface 104, and a memory 106, but not limited thereto. The processing unit 102 may comprise at least one data processor for executing program components for executing user or system-generated business processes. The processing unit 102 may comprise specialized processing units such as integrated system (bus) controllers, memory management control units, floating point units, graphics processing units, digital signal processing units, etc.

The memory 106 may include one or more of random access memory (RAM), read-only memory (ROM), flash memory, solid state drive (SSD), hard disk drive (HDD), dynamic random access memory (DRAM), static random access memory (SRAM), electrically erasable programmable read-only memory (EEPROM), or any combination thereof.

In various embodiments, the processing unit 102 may include more than one processors. Also, the processors may include one or more of a central processing unit (CPU), graphics processing unit (GPU), application-specific integrated circuit (ASIC), field-programmable gate array (FPGA), digital signal processor (DSP), neural processing unit (NPU), tensor processing unit (TPU), vision processing unit (VPU), or any combination thereof.

The processing unit 102 may communicate with one or more input/output (I/O) devices via I/O interface 104. The I/O interface 104 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 104, the system 100 may communicate with one or more I/O devices.

The system 100 may also include suitable logic, circuitry, and interfaces that may be configured to provide the process visualization and the simulated training. In an embodiment, the system 100 may be implemented in a computing device. The computing device may be a smartphone, tablet computer, laptop computer, desktop computer, workstation, server, mainframe computer, wearable device, smart glasses, head-mounted display, vehicle computing system, internet of things (IoT) device, consumer electronics device, or any combination thereof.

In an embodiment, the system 100 may estimate depth for a video in an event-sensor enabled electronic device where the at least one processor 102 of the system 100 may be configured to capture, using a camera of an electronic device, a current video frame and one or more previous video frames of a scene. In one implementation, the system 100 may receive the captured current video frame and one or more previous video frames of the scene through the I/O interface 104. As an example, the captured current video frame and one or more previous video frames of a scene may be stored as data 108 within memory 106. Furthermore, the at least one processor 102 may be configured to capture, using an event-sensor of the electronic device, one or more event frames for a time duration between the current video frame and each of the one or more previous video frames. In another implementation, the system 100 may receive the captured one or more event frames for a time duration between the current video frame and each of the one or more previous video frames through the I/O interface 104. As an example, the captured one or more event frames for a time duration between the current video frame and each of the one or more previous video frames may be stored as data 108 within memory 106.

In some embodiments, the system 100 may receive the sensor data (e.g., current video frame, one or more previous video frames) from devices (e.g., sensors, cloud) outside of the system 100 via the I/O interface. For example, an electronic device can be outside of the system 100 and include one or more of RGB sensors and event sensors.

In an embodiment, the captured current video frame and one or more previous video frames of the scene, and the captured one or more event frames for a time duration between the current video frame and each of the one or more previous video frames may be stored in memory 106 in the form of various data structures. Additionally, the aforementioned data may be organized using data models, such as relational or hierarchical data models.

In an embodiment, the captured current video frame and one or more previous video frames of the scene, and the captured one or more event frames for a time duration between the current video frame and each of the one or more previous video frames stored in the memory 106 may be processed by modules 110 of the system 100. The modules 110 may be stored within the memory 106 as shown in FIG. 1. As an example, modules 110, communicatively coupled to the processing unit 102, may also be present outside the memory 106.

In one implementation, the modules 110 may comprise, for example, an image capturing module 112, an event embedding module 114, a depth estimation module 116, a temporal propagation module 118, a depth fusion module 120, and other modules 122. The other modules 122 may be used to perform various functionalities of a system 100. It will be appreciated that such aforementioned modules may be represented as a single module or a combination of different modules. The modules may be implemented in any suitable hardware, software, firmware, or combination thereof. Furthermore, the modules 110 may be implemented by various techniques comprising but not limited to computer programs, one or more neural networks, machine learning algorithms, embedded systems design and cloud computing architectures. electronic device

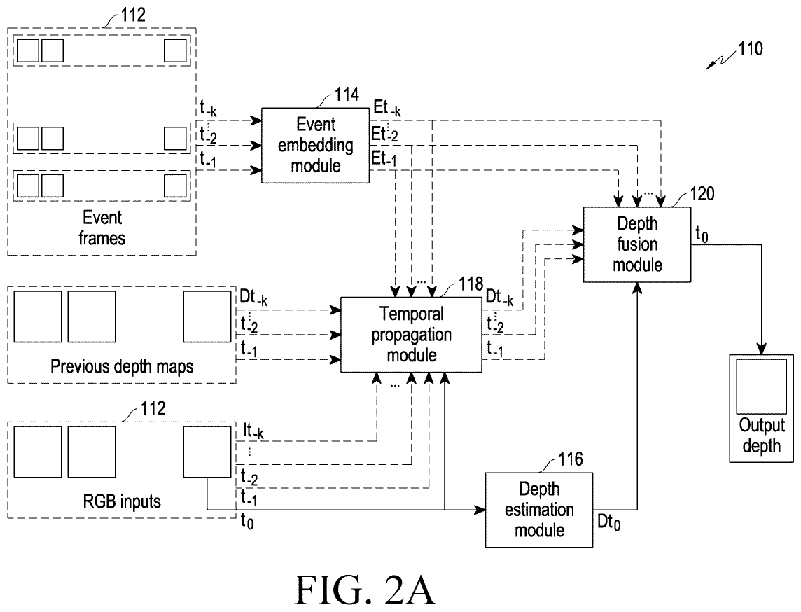

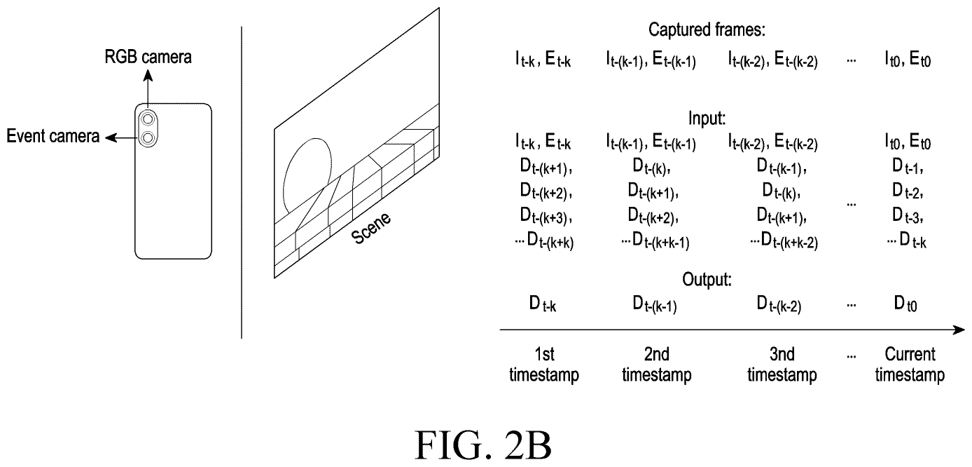

FIG. 2A illustrates a block diagram of an implementation of various modules 110 of the system 100, to estimate depth for a video in an event-sensor enabled electronic device, in accordance with an embodiment of the present disclosure. In an embodiment of the present disclosure, the image capturing module 112 may be configured to capture, using the camera of the electronic device, the current video frame (Iₜ) and one or more previous video frames (Iₜ₋ₖ) of the scene using the camera of a electronic device. For example, the camera of the electronic device may be an RGB camera. Further, the image capturing module 112 may be configured to capture, using an event sensor camera of the electronic device, one or more event frames for a time duration between the current video frame and each of the one or more previous video frames.

FIG. 2B illustrates a device with a RGB camera, an event sensor camera, and the timeline of their corresponding captured frames, in accordance with an embodiment of the present disclosure. The system 100 may use an even sensor camera in addition to the RGB camera because the event sensor camera outputs pixel-level brightness changes instead of standard RGB frames captured from the RGB camera. Additionally, the event sensor camera may function differently from the traditional RGB cameras by capturing changes in brightness/intensity at the pixel level rather than capturing complete images at fixed intervals. Furthermore, FIG. 2B illustrates the timeline of the captured frames from both the RGB camera and the event sensor camera. The system 100 may capture available ‘k’ frames. For example, for the first timestamp (time interval), only one frame (Iₜ) and event frame (Eₜ) may be used. Since there is no previous depth map, the temporal propagation module 118 and the depth fusion module 120 may not be used for the first time interval. However, for the second time interval, there may be two frames available i.e., both the current frame ((Iₜ), (Eₜ)) and the previous frame ((Iₜ₋₁), (Eₜ₋₁)) in addition to a previous depth map (Dₜ₋₁), and so on for subsequent time intervals.

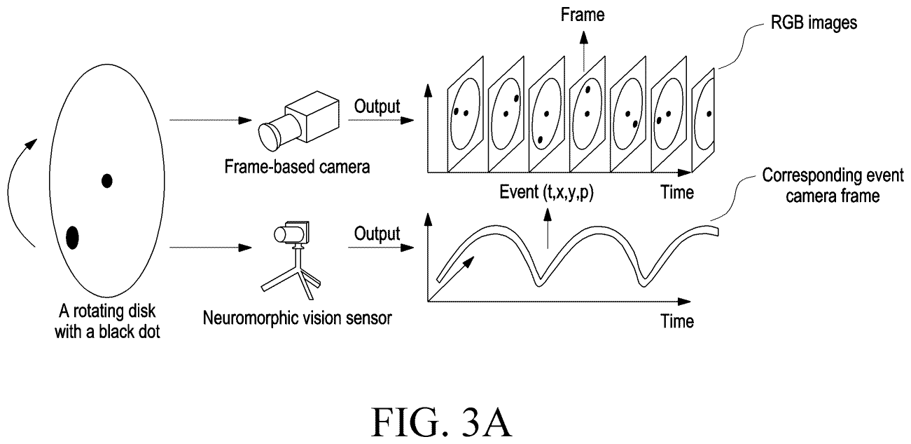

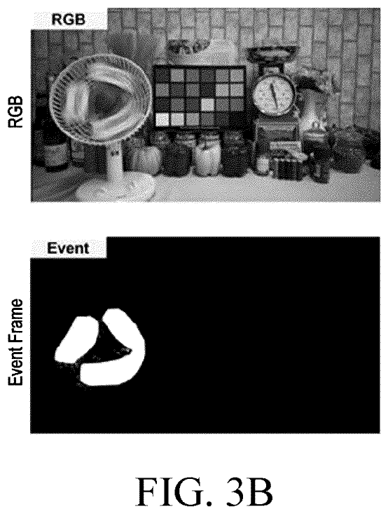

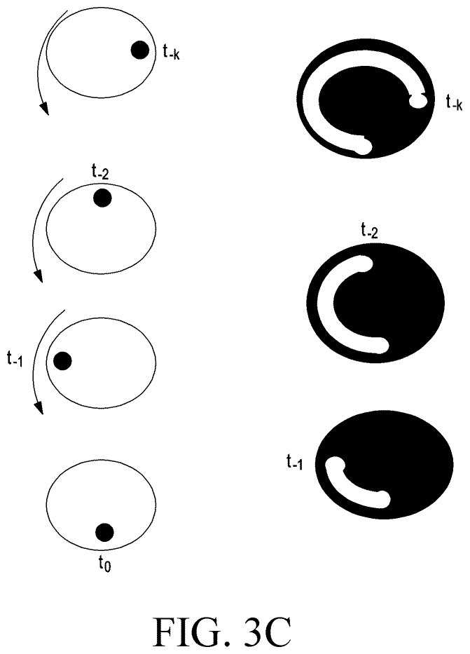

FIG. 3A illustrates an explanation of captured event frames using an event sensor camera of an electronic device, in accordance with an embodiment of the present disclosure. Each sensing unit in the event sensor camera may independently detect changes in brightness and generate an “event” only when a change is detected, such as when an object moves, or lighting conditions shift. Hence, the event sensor camera may produce a continuous stream of events indicating only the pixels where motion or change has occurred. Therefore, the event senor camera may capture the each of the one or more event frame pixels which has changed in video frames as illustrated below as an example.

FIG. 3B illustrates an example illustrating captured event frame using the event sensor camera of the electronic device, in accordance with an embodiment of the present disclosure. In this example, as illustrated in FIG. 3B, the RGB camera may record full-frame images at fixed time intervals, capturing the entire scene regardless of motion, however the event sensor camera of the electronic device may detect only changes in brightness at each pixel, generating an “event” only when motion occurs. For example, in FIG. 3B, as the fan blades rotate, they may cause brightness variations, which the event sensor camera records as event frame, capturing only the movement of the blades while ignoring the static background.

FIG. 3C illustrates another example to explain captured event frames using the event sensor camera of the electronic device, in accordance with an embodiment of the present disclosure. For example, FIG. 3C illustrates an example of a rotating disc with a black ball, where the ball is in circular anticlockwise direction. In an embodiment of the present disclosure, the event frames may be captured by the event sensor camera with respect to the current time interval (t₀). For example, as illustrated in FIG. 3C, when the ball moves from time interval (t₋ₖ) to (t₀), the captured event frame indicates that the ball has moved from anticlockwise from (t₋ₖ) to (t₀). Hence the output of the event sensor camera shows which pixels had motion from the last capture (t₋ₖ) to the current capture (t₀) time interval.

Referring again to FIG. 2A, FIG. 2A shows an event embedding module 114 to encapsulate the captured event frames data within a particular time duration. As illustrated above in FIG. 3C, the event sensor camera may capture pixel intensity changes that occur in the scene within the field of view. In order to effectively use data from event sensor cameras in predicting motion of the pixels in the scene, the event embedding module 114 may be used to preprocess the data from event sensor camera to generate event embeddings (Eₜ₋ₖ), to be used by at least other modules (e.g., temporal propagation module 118, depth fusion module 120), as discussed in the subsequent paragraphs.

In an embodiment of the present disclosure, the event embedding module 114 may be configured to take the event camera data and use those to generate event embeddings (e.g., time surface maps, 4D event queue, etc.). This event embedding may capture asynchronous pixel-wise change in intensities with micro-second resolutions, which make them useful for high speed and HDR scenes. The event embedding module 114 may ensure that the next modules in the system 100, such as temporal propagation module 118 and depth fusion module 120, have all the event information needed for effective temporal propagation.

Further, in an embodiment of the present disclosure, the event embedding module 114 may compute the event embeddings using the below mathematical relation:

$$Event embeddings = μ * {e}^{- ( \frac{t - {t}_{l a s t}}{η} )}$$

Here, t may refer to current time interval, tₗₐₛₜ may refer to last time interval where this pixel was active in an event frame and μ & η may refer to constants. The subsequent paragraphs will now explain the generation of the event embeddings from the event embedding module 114.

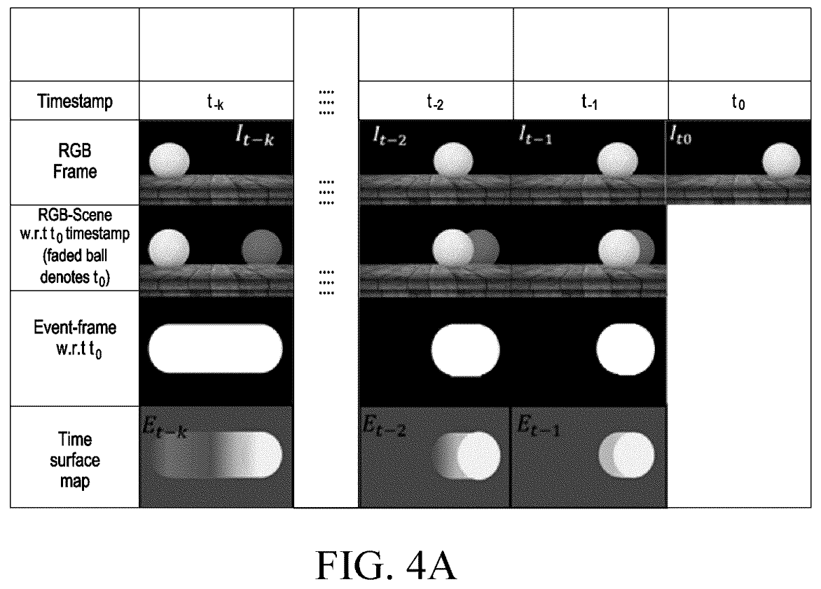

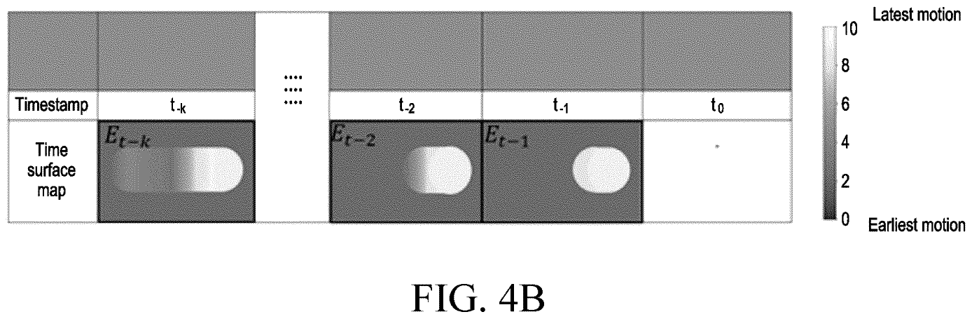

FIG. 4A illustrates an explanation of an event embedding module 114 to generate event embeddings, in accordance with an embodiment of the present disclosure. For example, FIG. 4A illustrates a captured RGB frame of a moving ball during the time interval (t₋ₖ) to (t₀) and the RGB scene depicting how the moving ball fades during the time interval (t₋ₖ) to (t₀). Furthermore, the event sensor camera of the electronic device may capture the pixels corresponding to the motion of the ball during the time interval (t₋ₖ) to (t₀). However, as the ball moves during the time interval (t₋ₖ) to (t₀), new events generated at the edges may be indicated as to active pixels in the event frame, while the older events gradually decay over time, leading to fading in the time surface map as depicted in event embeddings Eₜ₋ₖ, . . . , Eₜ₋₂, Eₜ₋₁.

FIG. 4B illustrates yet another explanation of the event embedding module 114 to generate event embeddings, in accordance with an embodiment of the present disclosure. As illustrated in FIG. 4B, as the time interval (t₋ₖ) to (t₀) increases, the event values may decrease exponentially. Hence, the time surface map shows the highest value for the recent points in motion and lowest value for the earliest pixels in motion. Hence, the time surface maps may give higher weight to more recent events and lower weight to previous events and form a weighted average of the event sensor data to form event embeddings Eₜ₋ₖ . . . , Eₜ₋₂, Eₜ₋₁ using the above mathematical relation, which are then combined with the corresponding one or more previous RGB frames (Iₜ₋ₖ, Iₜ₋₂, Iₜ₋₁) and depth maps (Dₜ₋ₖ, Dₜ₋₂, Dₜ₋₁) as input for the next modules which may be represented as ({Eₜ₋ₖ, Iₜ₋ₖ, Dₜ₋ₖ, Iₜ)} . . . {Eₜ₋₂, Iₜ₋₂, Dₜ₋₂, Iₜ}, {Eₜ₋₁, Iₜ₋₁, Dₜ₋₁, Iₜ}).

Further referring again to FIG. 2A, in an embodiment of the present disclosure, the depth estimation module 116 may estimate, a depth map (Dₜ) for each of the current video frame (Iₜ) and the one or more previous video frames (Iₜ₋ₖ) captured from the RGB camera of the electronic device. The depth estimation module 116 may predict the depth map output of the scene captured using a single image depth architecture. For example, the single image depth architecture may be a Convolutional neural network (CNN) architecture which may include encoder-decoder structures or variants with skip connections to capture multi-scale features that are useful for high resolution depth generation. The single image depth architecture may include transformers (e.g., vision transformers), recurrent neural networks (RNNs), graphic neural networks (GNNs), etc. Furthermore, in an example, the training of the depth estimation module 116 may be performed by supervised learning with depth annotations and loss functions such as Scale Invariant Mean Absolute Error (MAE) or Scale Invariant Mean Square Error (MSE). Image augmentations are also applied to the input during training to ensure robust performance during testing. However, training of the depth estimation module 116 may not be limited to supervised learning and may include unsupervised learning and semi-supervised learning.

Furthermore, in an embodiment of the present disclosure as illustrated in FIG. 2A, the temporal propagation module 118 may be configured to align the one or more depth maps of the one or more previous video frames with the depth map of the current video frame, using the change in pixel intensities captured in the one or more event frame. The temporal propagation module 118 takes event embedding (Eₜ₋ₖ), current RGB frame (Iₜ), (t−k)^{th} RGB frame (Iₜ₋ₖ), (t−k)^{th} depthmap (Dₜ₋ₖ) as input to generate an output of (t−k)^{th} depth map (Dₜ₋ₖ) aligned to t^{th} RGB frame (D′ₜ₋ₖ). For example, in an embodiment, the processor 102 may be configured to apply temporal transformation to each of the one or more depth maps of each of the one or more previous video frames and spatially shift depth values of pixels of each of the one or more previous video frames to align with corresponding pixel positions in the current video frame based on the temporal transformation. The network architecture of the temporal propagation module 118 to align the one or more depth maps is further explained in the subsequent paragraphs.

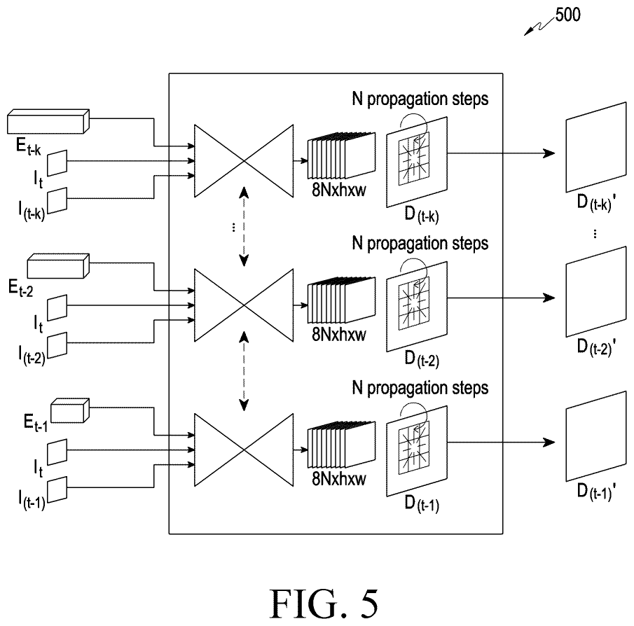

FIG. 5 illustrates a network architecture 500 of a temporal propagation module 118, in accordance with an embodiment of the present disclosure. The network architecture of the temporal propagation module 118 may be configured to take the following data as input:
Eₜ₋ₖ: event embedding constructed from all the event sensor data collected between the time interval (t−k) and t,
Iₜ: RGB frame at time interval t,
Iₜ₋ₖ: RGB frame at time interval (t−k), and
Dₜ₋ₖ: (t−k)^{th} depthmap output obtained from depth estimation module.

This network architecture of the temporal propagation module 118 to align the one or more depth maps may first generate affinity matrices (8N×h×w, where h and w are height and width of input RGB frame respectively) as output to be used for transforming the depth map output obtained from depth estimation module (Dₜ₋ₖ) to aligned depth map (D′ₜ₋ₖ) with respect to current time interval t, as illustrated in FIG. 5. For example, in an embodiment of the present disclosure the at least one processor 102 may be configured using the temporal propagation module 118 to iteratively generate a plurality of affinity matrices for each of the one or more previous video frames based on the current video frame, the previous video frame, and corresponding event frame. Further to apply the temporal transformation the at least one processor may be configured using the temporal propagation module 118 to spatially shift the depth values of pixels of the previous video frame to align with the corresponding pixel positions in the current video frame based on the plurality of affinity matrices, as explained in the subsequent paragraphs.

The temporal propagation module 118 may align the one or more depth maps of the one or more previous video frames Dₜ₋₁, Dₜ₋₂, . . . , Dₜ₋ₖ with the depth map of the current video frame (Dₜ) using the change in pixel intensities captured in the one or more event frame. To align these depth maps, the temporal propagation module 118 predicts the 8N×h×w affinity matrix using the current RGB video frame Iₜ, one or more previous RGB video frames Iₜ₋ₖ and the one or more previous depth maps D₍ₜ₋ₖ₎. In an embodiment of the present disclosure, at any particular forward flow, only one depth map may undergo this alignment process.

The temporal transformation may be performed through N number of iterations where each iteration uses the affinity matrices output obtained from the network architecture 500. In each iteration, the depth value of a pixel is propagated to its nearby neighbors using the equation given below.

$$D ( x , y , i + 1 ) = {\sum }_{j = 1}^{8} {W}_{{c}_{i , j}} ( x , y ) * D ( {x}_{N {b}_{j}} , {y}_{{Nb}_{j}} , i ) + ( 1 - {\sum }_{j = 1}^{8} {W}_{{c}_{i , j}} ( x , y ) ) * D ( x , y , i )$$

After each iteration step, the depth value at a pixel position may become the weighted sum of its nearby neighbors. These weights can be trained such that they will directionally shift the depth value spatially over the image, resulting in alignment with the t^{th} frame after N iterations.

However, temporal propagation may not be performed to all the pixels in the depth map. Some pixels in (t−k)^{th} frame might not have undergone any motion until it reaches t^{th} frame. Such static pixels may need to shift its depth values spatially as there has been no spatial movement at that position during this interval. Here, event embedding may be useful in separating such pixels from dynamic pixels that have undergone spatial shift in between frames.

The motion may be observed at a pixel location during time interval (t−k) and t if any of the event sensor data in between this interval has non-zero data. So, propagation step may only be performed at these pixel positions. The propagation step may be now modified as shown below:

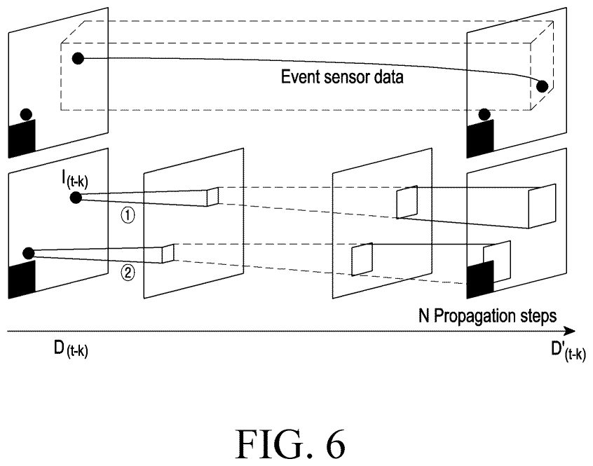

FIG. 6 illustrates an example to explain the temporal propagation module 118, in

$$D ( x , y , i + 1 ) = \{ \begin{matrix}( {\sum }_{j = 1}^{8} {W}_{{c}_{i , j}} ( x , y ) * D ( {x}_{N {b}_{j}} , {y}_{N {b}_{j}} , i ) + ( 1 - {\sum }_{j = 1}^{8} {W}_{{c}_{i , j}} ( x , y ) ) * D ( x , y , i ) \\ D ( x , y , i ) , othe r w i s e\end{matrix} ,$$

$$if {N}_{E} ( x , y ) \neq 0$$

where N_{E}(x,y) may refer to event embedding values in neighboring pixels. accordance with an embodiment of the present disclosure. For example, the at least one processor may be configured using the temporal propagation module 118 to identify a set of pixels of the previous video frame to apply the temporal transformation, which may have undergone spatial movement during the time duration based on the change in pixel intensities captured in the at least one event frame. The temporal transformation may be applied only to the identified set of pixels of the previous video frame as explained in the subsequent paragraphs.

For example, FIG. 6, there may be two balls in the scene. One ball may be stationary and sitting on the surface while the other ball may fall from top to bottom. The temporal propagation module 118 may focus only on the ball that undergoes motion, which is observed from the event camera senor data collected in between two consecutive RGB frames and applies iterative propagation only to the moving ball. It may not be necessary to apply temporal propagation to stationary ball, as frame-to-frame ball position has not changed. The temporal propagation module 118 of the present disclosure may be configured to skip temporal propagation of such stationary pixels which may be recognizable from the event sensor.

Further referring again to FIG. 2A, in an embodiment of the present disclosure, the depth fusion module 120 may be configured to fuse the aligned one or more depth maps of the one or more previous video frames with the depth map of the current video frame to generate consistent depth map (Dₜ) of the video. As illustrated in FIG. 2A, the input to the depth fusion module 120 may be the current frame depth map from depth estimation module 116, the previous k warped depthmaps output from the temporal propagation module (D′ₜ₋ₖ, . . . , D′ₜ₋₂, D′ₜ₋₁) and the event embeddings (Eₜ₋ₖ . . . , Eₜ₋₂, Eₜ₋₁). The following paragraphs shall now explain in detail the network architecture of the depth fusion module 120.

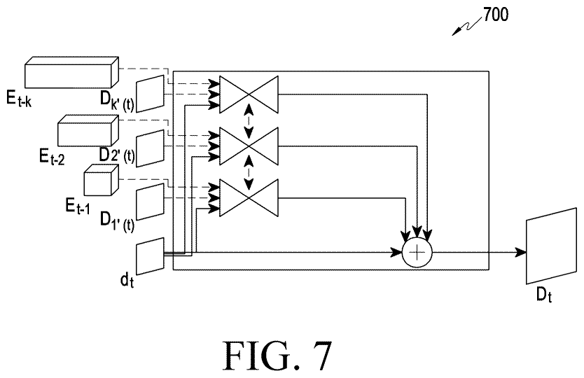

FIG. 7 illustrates a network architecture 700 of a depth fusion module 120, in accordance with an embodiment of the present disclosure. Depth generated by the depth estimation module 116 may not be temporally consistent because monocular depth map is not accurate but relative, so there is a need of a separate network architecture to generate a temporally consistent depth map. In an embodiment of the present disclosure, the depth fusion module 120 generates the temporally consistent depth map (Dₜ) based on k aligned depth maps, corresponding event embedding Eₜ₋ₖ and current frame depth map (dₜ). Event embedding may provide information on which pixels have undergone more motion among all the forward processing of previous depth maps. If a pixel has undergone more motion in Eₜ₋ₖ compared to Eₜ₋ₗ then l^{th} warped depth would have more reliable depth values than kth warped depth. The network architecture of the depth fusion module 120 may learn which previous warped depth maps are more reliable and accordingly add residual correction to the output of depth estimation module 116 to generate the temporally consistent final or updated output.

Further, in an embodiment of the present disclosure, for dynamic and moving pixels, weighted averaging may be used for moving pixels. For example, in an embodiment of the present disclosure, the at least one processor may be configured to fuse weighted average of the aligned one or more depth maps with the depth map of the current video frame based on the corresponding one or more event frames. As a result, slow-moving pixels and fast-moving pixels may be differentiated based on the change in pixel intensities.

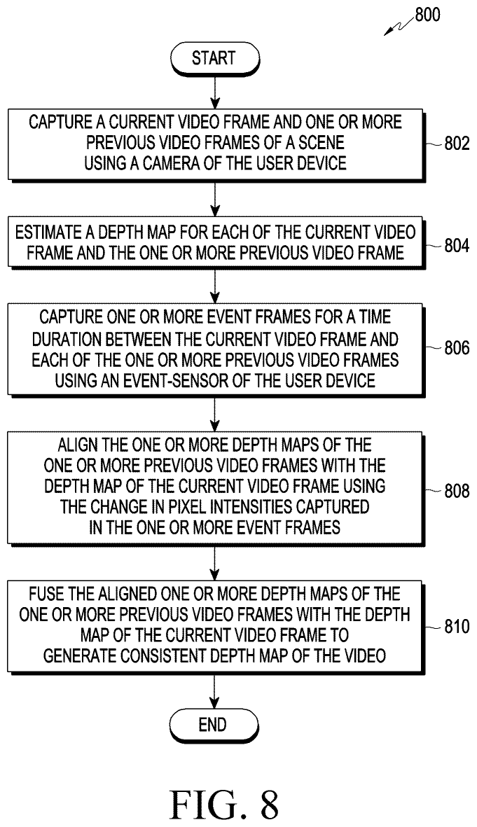

FIG. 8 illustrates a sequence flow of a method 800 of depth estimation for a video in an event-sensor enabled electronic device, in accordance with an embodiment of the present disclosure.

At step 802, the method may comprise capturing a current video frame (Iₜ) and the one or more previous video frames (Iₜ₋ₖ) of a scene using a camera of the electronic device by an image capturing module 112. The camera of the electronic device may be an RGB camera. Furthermore, the captured current video frame (Iₜ) and the one or more previous video frames (Iₜ₋ₖ) may be sent to the depth estimation module 116 for estimating the depth map for each of the captured current video frame (Iₜ) and the one or more previous video frames (Iₜ₋ₖ), as discussed in subsequent paragraphs.

At step 804, the method may further comprise estimating a depth map for each of the current video frame (Iₜ) and the one or more previous video frame (Iₜ₋ₖ), captured from the RGB camera of the electronic device. In an embodiment of the present disclosure, the depth estimation module 116 may estimate, the depth map (Dₜ) for each of the current video frame (Iₜ) and the one or more previous video frames (Iₜ₋ₖ) captured from the RGB camera of the electronic device. The depth estimation module 116 may predict the depth map output of the scene captured using a single image depth architecture. For example, the single image depth architecture may be a Convolutional neural network (CNN) architecture which consists of encoder-decoder structures or variants with skip connections to capture multi-scale features that are useful for high resolution depth generation. Furthermore, in an example, the training of the depth estimation module 116 may be done by supervised learning with depth annotations with loss functions such as Scale Invariant Mean Absolute Error (MAE) or Scale Invariant Mean Square Error (MSE). Image augmentations are also applied to the input during training to ensure robust performance during testing. Furthermore, the generated depth map output (Dₜ) may be post-processed by performing, for example, smoothing or depth quality improvement techniques to further refine the depth map output. FIG. 2A explains the depth estimation module 116 to estimate the depth of the captured frames from the RGB camera of the electronic device and has not been repeated for the sake of brevity.

At step 806, the method may further comprise capturing, by an image capturing module 112, one or more event frames during a time period between the current video frame and each of the one or more previous video frames using an event-sensor of the electronic device. The each of the one or more event frames may capture pixels which have changed in video frames. The devices and/or modules may utilize event sensor camera in addition to the RGB camera because the event sensor camera outputs pixel-level brightness changes instead of standard RGB frames captured from the RGB camera. Additionally, event sensor camera may function differently from the traditional RGB cameras by capturing changes in brightness at the pixel level rather than capturing complete images at fixed intervals. FIG. 3A illustrates an explanation of captured event frames using an event sensor camera of the electronic device, and FIGS. 3B-3C illustrate examples to explain captured event frames using the event sensor camera of the electronic device, in accordance with an embodiment of the present disclosure, and the same has not been repeated for the sake of brevity. Furthermore, in order to effectively use data from event sensor cameras in predicting motion of the pixels in the scene, the event embedding module 114 may be used to preprocess the data from the event sensor camera resulting in event embeddings (Eₜ₋ₖ). FIGS. 4A-4B illustrate explanations of the event embedding module 114 to generate event embeddings, in accordance with an embodiment of the present disclosure and the same has not been repeated for the sake of brevity.

At step 808, the method may further comprise aligning the one or more depth maps of the one or more previous video frames with the depth map of the current video frame using the change in pixel intensities captured in the one or more event frames. In an embodiment of the present disclosure, the temporal propagation module 118 may align the one or more depth maps of the one or more previous video frames with the depth map of the current video frame, using the change in pixel intensities captured in the one or more event frame. The temporal propagation module 118 may receive event embedding (Eₜ₋ₖ), current RGB frame (Iₜ), (t−k)^{th} RGB frame (Iₜ₋ₖ), (t−k)^{th} depthmap (Dₜ₋ₖ) as inputs to generate an output of (t−k)^{th} depth map (Dₜ₋ₖ) aligned to t^{th} RGB frame (D′ₜ₋ₖ). The method may further comprise spatially shifting, by the temporal propagation module 118, depth values of pixels of each of the one or more previous video frames to align with corresponding pixel positions in the current video frame by applying temporal transformation to each of the one or more depth maps of each of the one or more previous video frames.

The method may further comprise applying the temporal transformation by iteratively performing, for each of the one or more previous video frames, the operations of generating a plurality of affinity matrices based on the current video frame, the previous video frame, and corresponding event frame and spatially shifting the depth values of pixels of the previous video frame to align with the corresponding pixel positions in the current video frame based on the plurality of affinity matrices as explained above in FIG. 5. The same has not been repeated for the sake of brevity.

Furthermore, aligning the depth map of the previous video frame with the depth map of the current video frame may include identifying a set of pixels of the previous video frame to apply the temporal transformation, which have undergone spatial movement during the time duration based on the change in pixel intensities captured in the at least one event frame. For example, the temporal transformation in the present disclosure may be applied only to the identified set of pixels of the previous video frame, as illustrated above in FIG. 6.

At step 810, the method may further comprise fusing the aligned one or more depth maps of the one or more previous video frames with the depth map of the current video frame to generate consistent depth map of the video. In an embodiment of the present disclosure, fusing the aligned one or more depth maps of the one or more previous video frames with the depth map of the current video frame video using a depth fusion module 120 may include fusing weighted average of the aligned one or more depth maps with the depth map of the current video frame based on the corresponding one or more event frames. In an embodiment of the present disclosure, the depth fusion module 120 may generate the required temporally consistent depth map (Dₜ) using previous k depthmaps, corresponding event embedding Eₜ₋ₖ and current frame depth map (dₜ) real time. Event embedding as input may provide information on which pixels have undergone more motion among all the forward processing of previous depth maps. For example, the weighted average is dynamically adjusted to differentiate between slow and fast moving pixels based on the change in pixel intensities, as illustrated above in FIG. 7 and the same has not been repeated for the sake of brevity.

The order in which the various operations of the methods are described is not intended to be construed as a limitation, and any number of the method described blocks can be combined in any order to implement the method. For example, operations may be performed sequentially, in a different order, in parallel, or with some operations skipped or repeated. Additionally, individual blocks may be deleted from the methods without departing from the spirit and scope of the subject matter described herein. Furthermore, the methods can be implemented in any suitable hardware, software, firmware, or combination thereof. It may be noted here that the subject matter of some or all embodiments described with reference to FIGS. 1-8 may be relevant for the methods and the same is not repeated for the sake of brevity.

The various operations of methods described above may be performed by any component capable of performing the corresponding functions. The components may include various hardware and/or software component(s) and/or module(s), including, but not limited to a circuit, an application specific integrated circuit (ASIC), or processor. Generally, where there are operations illustrated in FIGS. 1-8, those operations may be performed by any suitable corresponding hardware or software.

As a result of performing one or more operations described herein, certain technical benefits or advantages can be achieved. For example, by at least using the output depth described in conjunction with FIG. 2, a high-quality Portrait effect in a live stream video may be enabled. Also, as temporal consistency is ensured by at least aligning and fusing depth maps, advanced effects on videos can be performed using the temporally consistent depth maps.

Furthermore, one or more computer-readable storage media may be utilized in implementing embodiments consistent with the present disclosure. A computer-readable storage medium may refer to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

A computer program may perform the operations presented herein. For example, the computer program product may include a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” may mean “one or more”, unless expressly specified otherwise.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

Number of items in a plurality is at least two, but can be more when so indicated either explicitly or by context.

Terms such as “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. While various aspects and embodiments have been disclosed herein, other aspects and embodiments will be apparent to those skilled in the art.

What is claimed is:

1. A method for depth estimation of a video, the method comprising:
capturing a current video frame and one or more previous video frames of a scene using a camera of an electronic device;
estimating a depth map for each of the current video frame and the one or more previous video frames;
capturing one or more event frames over a time period between the current video frame and each of the one or more previous video frames using an event-sensor of the electronic;
aligning the depth map of the one or more previous video frames with the depth map of the current video frame using a change in pixel intensities indicated by the one or more event frames; and
generate an updated depth map of the video based on the aligned depth map of the one or more previous video frames and the depth map of the current video frame.

2. The method of claim 1, wherein the camera of the electronic device is an RGB camera.

3. The method of claim 1, wherein the aligning of the depth map of the one or more previous video frames with the depth map of the current video frame comprises:
applying temporal transformation to the depth map of each of the one or more previous video frames; and
spatially shifting depth values of pixels of each of the one or more previous video frames to align with corresponding pixel positions in the current video frame based on the temporal transformation.

4. The method of claim 3, wherein the aligning of the depth map of the one or more previous video frames with the depth map of the current video frame further comprises:
for each of the one or more previous video frames, iteratively:
generating a plurality of affinity matrices based on the current video frame, a respective previous video frame, and a corresponding event frame; and
spatially shifting the depth values of pixels of the respective previous video frame to align with the corresponding pixel positions in the current video frame based on the plurality of affinity matrices.

5. The method of claim 4, wherein the aligning of the depth map of the one or more previous video frames with the depth map of the current video frame further comprises:
identifying a set of pixels of the one or more previous video frames to apply the temporal transformation based on the change in pixel intensities captured in the one or more event frames, the set of pixels corresponding to spatial movement during the time period,
wherein the temporal transformation is applied only to the identified set of pixels of the one or more previous video frames.

6. The method of claim 1, wherein the fusing of the aligned depth map of the one or more previous video frames with the depth map of the current video frame comprises:
fusing an weighted average of the aligned depth map with the depth map of the current video frame based on corresponding one or more event frames,
wherein the weighted average is to differentiate slow and fast moving pixels based on the change in pixel intensities.

7. The method of claim 1, further comprising:
generating, based on the one or more event frames, event embedding that indicates the change in pixel intensities, and
wherein the one or more event frames includes pixels which have changed in video frames.

8. An electronic device, comprising:
at least one processor;
memory storing at least one instruction;
wherein the at least one instruction, when executed by the at least one processor individually or collectively, cause the system to:
capture, using a camera, a current video frame and one or more previous video frames of a scene;
estimate a depth map for each of the current video frame and the one or more previous video frames;
capture, using an event-sensor, one or more event frames during a time period between the current video frame and each of the one or more previous video frames;
align the depth map of the one or more previous video frames with the depth map of the current video frame using a change in pixel intensities indicated by the one or more event frames; and
generate an updated depth map of the video based on the aligned depth map of the one or more previous video frames and the depth map of the current video frame.

9. The electronic device of claim 8, wherein the camera is an RGB camera.

10. The electronic device of claim 8, wherein the at least one instruction, when executed by the at least one processor individually or collectively, further cause the system to:
apply temporal transformation to the depth map of each of the one or more previous video frames; and
spatially shift depth values of pixels of each of the one or more previous video frames to align with corresponding pixel positions in the current video frame based on the temporal transformation.

11. The electronic device of claim 10, wherein the at least one instruction, when executed by the at least one processor individually or collectively, further cause the system to:
for each of the one or more previous video frames, iteratively:
generate a plurality of affinity matrices based on the current video frame, a respective previous video frame, and corresponding event frame; and
spatially shift the depth values of pixels of the respective previous video frame to align with the corresponding pixel positions in the current video frame based on the plurality of affinity matrices.

12. The electronic device of claim 11, wherein the at least one instruction, when executed by the at least one processor individually or collectively, further cause the system to:
identify a set of pixels of the one or more previous video frames to apply the temporal transformation based on the change in pixel intensities captured in the one or more event frames, the set of pixels corresponding to spatial movement during the time period,
wherein the temporal transformation is applied only to the identified set of pixels of the one or more previous video frames.

13. The electronic device of claim 8, wherein the at least one instruction, when executed by the at least one processor individually or collectively, further cause the system to:
fuse an weighted average of the aligned depth map with the depth map of the current video frame based on corresponding one or more event frames,
wherein the weighted average is to differentiate slow and fast moving pixels based on the change in pixel intensities.

14. The electronic device of claim 8, wherein the at least one instruction, when executed by the at least one processor individually or collectively, further cause the system to:
generate, based on the one or more event frames, event embedding that indicates the change in pixel intensities, and
wherein each of the one or more event frames includes pixels which have changed in video frames.

15. A non-transitory computer readable storage medium storing instructions that, when executed by one or more processors, cause the electronic device to:
capture, using a camera, a current video frame and one or more previous video frames of a scene;
estimate a depth map for each of the current video frame and the one or more previous video frames;
capture, using an event-sensor, one or more event frames during a time period between the current video frame and each of the one or more previous video frames;
align the depth map of the one or more previous video frames with the depth map of the current video frame using a change in pixel intensities indicated by the one or more event frames; and
generate an updated depth map of the video based on the aligned depth map of the one or more previous video frames and the depth map of the current video frame.

16. The non-transitory computer readable storage medium of claim 15, wherein the camera is an RGB camera.

17. The non-transitory computer readable storage medium of claim 15, wherein the instructions further include instructions that, when executed by one or more processors, cause the electronic device to:
apply temporal transformation to the depth map of each of the one or more previous video frames; and
spatially shift depth values of pixels of each of the one or more previous video frames to align with corresponding pixel positions in the current video frame based on the temporal transformation.

18. The non-transitory computer readable storage medium of claim 17, wherein the instructions further include instructions that, when executed by one or more processors, cause the electronic device to:
for each of the one or more previous video frames, iteratively:
generate a plurality of affinity matrices based on the current video frame, a respective previous video frame, and corresponding event frame; and
spatially shift the depth values of pixels of the respective previous video frame to align with the corresponding pixel positions in the current video frame based on the plurality of affinity matrices.

19. The non-transitory computer readable storage medium of claim 18, wherein the instructions further include instructions that, when executed by one or more processors, cause the electronic device to:
identify a set of pixels of the one or more previous video frames to apply the temporal transformation based on the change in pixel intensities captured in the one or more event frames, the set of pixels corresponding to spatial movement during the time period,
wherein the temporal transformation is applied only to the identified set of pixels of the one or more previous video frames.

20. The non-transitory computer readable storage medium of claim 15, wherein the instructions further include instructions that, when executed by one or more processors, cause the electronic device to:
fuse an weighted average of the aligned depth map with the depth map of the current video frame based on corresponding one or more event frames,
wherein the weighted average is to differentiate slow and fast moving pixels based on the change in pixel intensities, and
wherein each of the one or more event frames includes pixels which have changed in video frames.
